(19) United States
(12) Patent Application Publication
(10) Pub. No.: US 2025/0002739 A1
(43) Pub. Date: Jan. 2, 2025

(54) INKJET INK AND PRIMER FLUID SET

(71) Applicant: DUPONT ELECTRONICS, INC., Wilmington, DE (US)

(72) Inventor: Xiaoqing Li, NEWARK, DE (US)

(21) Appl. No.: 18/710,230

(22) PCT Filed: Oct. 28, 2022
(86) PCT No.: PCT/US2022/078847

§ 371 Date: May 15, 2024

Related U.S. Application Data
(60) Provisional application No. 63/289,347, filed on Dec. 14, 2021.

(51) Int. Cl. C09D 11/40; C09D 11/102; C09D 11/107; C09D 11/54

(52) U.S. Cl. CPC C09D 11/40; C09D 11/102; C09D 11/107; C09D 11/54

(57) ABSTRACT

The present disclosure provides an ink fluid set containing an aqueous primer coating fluid and an aqueous inkjet ink or inkjet ink set. The aqueous primer coating fluid comprises two parts that are mixed together prior to application to form a coating on a print substrate. The aqueous inkjet ink or inkjet ink set is subsequently printed on the primer coated substrate. This fluid set is particularly suitable for printing on non-porous plastic substrate.

### CROSS REFERENCE TO RELATED APPLICATIONS

This application claims priority under 35 U.S.C. § 119 from U.S. Provisional Application Ser. No. 63/289,347, filed Dec. 14, 2021

### BACKGROUND OF THE DISCLOSURE

This disclosure pertains to an ink fluid set containing an aqueous primer coating fluid and an aqueous inkjet ink or inkjet ink set. The aqueous primer coating fluid comprises two parts that are mixed together prior to application to form a coating on a substrate. The aqueous inkjet ink or inkjet ink set is subsequently printed on the primer coated substrate.

Inkjet printing is a non-impact digital printing process in which droplets of ink are deposited on a substrate, such as paper, to form the desired image. Inkjet printers are equipped with an ink set which, for full color printing, typically comprises a cyan, magenta and yellow ink (CMY). An ink set also typically comprises a black ink (CMYK) with the black ink being the most common ink. For transparent substrate such as clear plastics, a white ink is commonly needed for enhancing color images. In this case, an ink set typically comprises CMYKW inks.

Inkjet printing is becoming increasingly important for markets other than conventional desktop printing for small office/home office. Digital printing methods have gained popularity in textiles, commercial and packaging printing and offer several potential benefits over conventional printing methods such as screen printing, offset printing, flexo and gravure printing. Inkjet digital printing eliminates the setup expense associated with screen and plate preparation and can potentially enable cost effective short run production. Inkjet printing furthermore allows visual effects such as tonal gradients and infinite pattern repeat sizes that cannot be practically achieved with a screen and other analog printing processes.

Aqueous inkjet ink has grown rapidly in packaging application in recent years, because it is a digital technology with less environmental impact compared to UV and solvent digital inks. Non-porous plastics, including both flexible plastic films and rigid plastics, are common media/substrate for packaging applications. The surfaces of these plastics are non-liquid absorbing and hydrophobic by nature, and impose many performance challenges for aqueous pigmented inks. Among them a key challenge is poor image quality due to slow setting of the ink drops as the results of non-ink absorbing of the printing surface and low drying temperature to avoid damaging the printed plastic substrates or films. Another major challenge is an ink's poor adhesion to non-porous plastic films, specifically poor lamination strength when a printed plastic film is laminated to another film to form a multi-layer laminated structure for a variety of packaging applications. Slow fixation and drying of ink drops can lead to blurry image and inter-color bleed, and weak bonding strength of the laminated structure can lead to delamination of the packaging materials.

To improve print image quality on a hydrophobic substrate, a common approach is to coat the hydrophobic surface with a primer or pretreatment fluid. U.S. Patent Application Publication No. 2008/0092309 discloses a pretreatment solution for treating textile. The pretreatment solution contains a nonionic latex polymer and a multivalent cationic salt solution. U.S. Patent Application Publication No. 2014/356555 discloses an inkjet printing media containing a base substrate and a coating layer. The coating layer contains a source of polyvalent ions and a latex binder that forms a coherent film in the presence of the polyvalent ions. The base substrate may include paper, cloth, nonwoven fabric, felt, and synthetic (non-cellulosic) papers. However, these disclosures do not address printing on a non-porous plastic film substrate which differs from other common substrates in that a non-porous plastic film is completely non-liquid permeable and difficult to adhere to due to weak interaction between plastic polymers and inks, and that a non-porous plastic film often requires low drying and curing temperature to accommodate a film that is less tolerant to heat.

JP2011189527 discloses a recording pretreatment liquid comprises a water soluble carbodiimide group containing resin, and an ink comprising a particle containing carboxy functional polymer. The carboxy functional polymer in the ink reacts with the carbodimide in the pretreatment upon printing. U.S. Patent Application Publication No. 20190390078 discloses an ink set for printing on films. The ink set contains a pretreatment liquid having a coagulant, water, polyester, polyolefin, and polyurethane. The ink in the ink set contains a pigment and a compound having an oxazoline group. The components in the pretreatment and the ink chemically react after printing on an ink recording media. JP2019006855 discloses a recording liquid set for printing on non-absorbing base material that can result in high lamination strength. The recording liquid set includes an aqueous undercoating liquid containing an amphoteric resin and a coagulant, and can further contain a crosslinking agent, including epoxy type crosslinking agent, isocyanate type crosslinking agent, carbodiimide-type crosslinking agent, etc. All these references disclose approaches where component(s) in pretreatment/undercoating liquid(s) chemically reacts with component(s) in ink(s).

A need exists for an improved inkjet ink set and primer fluid combination that can produce higher quality print images on non-porous plastic film surfaces, especially with stronger lamination strength and better adhesion to plastic films that are widely used as packaging materials. The present disclosure satisfies this need by providing an inkjet ink and a 2-part primer fluid set containing a primer, and inkjet ink(s). The 2-part primer contains Part A and Part B that are mixed prior to application to form a primer coating. This freshly formed primer coating interacts with the inkjet ink(s) to achieve higher quality print images on non-porous plastic films with strong lamination strength.

### SUMMARY OF THE DISCLOSURE

An embodiment of the present disclosure provides an inkjet printing fluid set comprising:
a) a 2-part aqueous primer coating fluid comprising Part A and Part B, wherein Part A comprising an ink aggregating agent, a water insoluble polymer binder selected from polyurethane polymer, acrylic polymer, polyvinyl acetate copolymer, and mixtures thereof, Part B comprising a water dispersible co-reactant selected from polyisocyanate, epoxy, epoxy silane, carbodiimide, and mixtures thereof, wherein Part A and Part B are mixed before the primer coating fluid is to be applied to a recording media, and wherein Part A and Part B are mixed at a ratio in the range of from 100:1 to 100:20, based on the total weights of Part A and Part B; and
b) an aqueous inkjet ink comprising an aqueous vehicle, and a pigment, wherein the pigment is stabilized by a polymeric dispersant selected from the group consisting of polyurethane polymer, acrylic polymer, hydrolyzed styrene maleic anhydride copolymer, and mixtures thereof.

Another embodiment of the present disclosure provides that the water insoluble polymer binder in Part A is polyurethane polymer.

Another embodiment of the present disclosure provides that the water dispersible co-reactant in Part B is polyisocyanate.

Another embodiment of the present disclosure provides that the polymeric dispersant is polyurethane polymer.

Another embodiment of the present disclosure provides that the polymeric dispersant is acrylic polymer.

Another embodiment of the present disclosure provides that the water insoluble polymer binder in Part A is acrylic polymer.

Yet another embodiment of the present disclosure provides that the water insoluble polymer binder in Part A is polyvinyl acetate copolymer.

These and other features and advantages of the present embodiments will be more readily understood by those of ordinary skill in the art from a reading of the following de-tailed description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two-phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

The materials, methods, and examples herein are illustrative only except as explicitly stated, and are not intended to be limiting.

In addition, references in the singular may also include the plural (for example, “a” and “an” may refer to one, or one or more) unless the context specifically states otherwise.

### Non-Porous Plastic Substrate

Non-porous plastic substrate or film is one of the main substrates used in flexible packaging. Flexible packaging is a container made of materials that can be quickly changed in shape when they're filled or closed. These containers can use paper, non-porous plastic film or foil materials in any combination. A non-porous plastic film is typically made of: High Density Polyethylene (HDPE),
Medium Density Polyethylene (MDPE),
Low Density Polyethylene (LDPE) Includes Linear Low Density Polyethylene (LLDPE),
Polyethylene Terephthalate (PET), Metallized PET (Met-PET), glass coated PET, acrylic coated PET,
Polypropylene (PP) includes Casted PP (CPP), Oriented PP (OPP), Biaxial Oriented PP (BOPP) and Metallized OPP (MOPP),
Polystyrene,
Nylon,
Polyvinyl Chloride (PVC, Vinyl),
Ethylene Vinyl Acetate polymer (EVA), and
Ethylene Vinyl Alcohol copolymer (EVOH).

Each film features different capabilities and characteristics that makes it suitable for specific applications. Alternatively, the films can be combined to create multilayer films with distinct barrier properties for better protection or longer shelf life. The customization element extends to visual properties as well, including clarity, glossiness, and high-quality printed graphics in an array of colors and designs to wrap the product in style and to include important information right on the package. These substrate films may be non-oriented or oriented films. The thickness of the substrate film is not critical, but usually only needs to be in the range of 1 to 500 μm. The print surface of the substrate film has preferably been treated with a corona discharge. Silica or alumina, for example, may have been deposited on the surface of the film.

### Primer Composition

A 2-part primer coating fluid is employed in the present disclosure. Part A of the primer coating fluid contains an ink aggregating agent, a water insoluble polymer binder selected from polyurethane polymer, acrylic polymer, polyvinyl acetate copolymer, and mixtures thereof. Part B of the primer coating fluid contains a water dispersible co-reactant selected from polyisocyanate, epoxy, epoxy silane, carbodiimide, and mixtures thereof. The mixing ratio of Part A and Part B is typically in the range of from 100:1 to 100:20, more typically in the range of from 100:1 to 100:15, based on the total weights of Part A and Part B. The ink aggregating agent and water insoluble polymer binder in Part A chemically reacts with the co-reactant in Part B at temperature lower than 85° C.

### Primer Part a

Primer Part A comprises an ink aggregating agent, and a water insoluble polymer binder selected from polyurethane, acrylic and polyvinyl acetate copolymers. Part A should comprise enough ink-aggregating agent to provide adequate fixation of the inkjet inks. Typically, Part A comprises at least about 0.5 wt % of the ink-aggregating agent. The maximum amount of the ink-aggregating agent is limited by the solubility of the particularly ink-aggregating agent utilized. Preferably, Part A comprises from about 1 wt % to about 30 wt % of the ink-aggregating agent, based on the total weight of the Part A fluid.

### Ink-Aggregating Agent

The primer Part A solution contains an ink-aggregating agent that “precipitates” or “crashes” with a colorant or other ingredient(s) in an ink. Preferred ink-aggregating agents include multivalent metal salts, and/or organic acid.

“Multivalent” indicates an oxidation state of two or more and, for an element “Z”, are typically described as Z²⁺, Z³⁺, Z⁴⁺ and so forth. For brevity, multivalent cations may be referred to herein as Z^{x}. The multivalent cations are substantially soluble in the aqueous primer solution and preferably exist (in solution) in a substantially ionized state so that they are in a form where they are free and available to interact with the inkjet inks.

Z^{x} includes, but is not limited to multivalent cations of the following elements: Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb. In another embodiment, the multivalent cation comprises at least one of Mg, Ca, Ba, Ru, Co, Zn and Ga. In yet another embodiment, the multivalent cation comprises at least one of Ca, Ba, Ru, Co, Zn and Ga. Preferably the multivalent cations are Mg and Ca.

Z^{x} can be incorporated into primer solution by addition in a salt form or by addition in an alkaline form and used as a base in the adjustment of the primer solution pH.

The associated anionic material can be chosen from any common anionic material, especially halides, nitrates and sulfates. The anionic form is chosen so that the multivalent cation is soluble in the aqueous primer solution. The multivalent cationic salts can be used in their hydrated form. One or more multivalent cationic salts may be used in the primer solution.

For Ca, the preferred multivalent cation salts are calcium chloride, calcium nitrate, calcium nitrate hydrate and mixtures thereof.

For Mg, the preferred multivalent cation salts are magnesium chloride, magnesium nitrate, magnesium nitrate hydrate and mixtures thereof.

An organic acid as aggregating agent precipitates ink drops by lowering the ink's pH and coagulating pigment dispersion and other ink components. Specific examples of acids are polyacrylic acid, acetic acid, glycolic acid, malonic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid and derivatives of these compounds. Polyacrylic acid and acetic acid are particularly preferred.

### Primer Polymeric Binder

The primer Part A solution contains compatible polymeric binder(s) which do not “precipitate” or “crash” with the aggregating agent. The primer polymeric binder and ink-aggregating agent solution thus formed must be stable as a solution or as a stable emulsion to permit the coating of the film substrate. If the primer polymeric binder gels, or its emulsion precipitates in the presence of an ink-aggregating agent, e.g., a multivalent cationic salt solution, then it cannot be used as a primer additive. A screening test to determine whether a primer polymeric binder is stable in the presence of an ink-aggregating agent is to mix a 10 wt % polymer (on a dry basis) and a 15 wt % of calcium nitrate tetrahydrate and observe whether the solution/emulsion is stable. The stability is observed at ambient temperature (˜ 25° C.), and at intervals of 10 minutes and 24 hours. The primer polymeric binder must lead to a stable polymer/multivalent cationic solution/emulsion mixture.

Some suitable compatible polymeric binders include, for example, non-ionic water insoluble polymers in colloidal particle form which include acrylic latexes, polyurethane dispersions, vinyl acetate copolymer latexes, polyester and polyamide dispersions. These polymers may be made by any known process including, but not limited to, free radical, group transfer, ionic, RAFT, condensation and other types of polymerization.

A primer polymeric binder can be formed from the incorporation of a nonionic stabilizer either chemically bound or physically absorbed into the polymer. Examples of nonionic reactive components include, ethylene oxide derivatives, acrylamide, hydroxyethyl-substituted monomers, vinylpyrrolidone, ethyleneamines, and the like. The incorporation can occur during the polymerization step, or after the polymerization step which prepares the latex polymer. In the case of an ethylene oxide nonionic component, the substitution can take the form of incorporating a glycol with sufficient (—CH₂—CH₂O—) n units to impart the nonionic stability. For instance, a polyurethane may have an alkyl polyethylene glycol incorporated into the nonionic polyurethane. The nonionic component can be the main component in nonionic latex polymer, as long as its properties satisfy the stability test described above.

A primer polymeric binder may also have ionic components incorporated into the polymer. By example, for the polyurethanes ionic components such as acids may be used in the polyurethane reaction and a specific acid example is dimethylolpropionic acid. For the acrylamide and hydroxyethyl substituted nonionic latex polymer, the ionic source can be from (meth)acrylic acids. There are limits to the contents of ionic components in the polymer, since the ionic components may complex with the ink-aggregating agent that will lead to instability of the polymer/multivalent cationic solution. The balance of nonionic and ionic components must lead to a stable solution as described above.

The polymeric binder is combined with an ink-aggregating agent to form the Part A fluid. The polymeric binder is advantageously used at levels of at least about 5%, and typically at least about 10%, based on the total weight of Part A fluid. Upper limits are dictated by primer viscosity or other physical limitations. In a more typical embodiment, no more than about 50% polymeric binder is present in the Part A composition, and even most typically no more than about 40%, based on the total weight of the primer Part A fluid. The combined total weight of the polymeric binder and ink-aggregating agent can be up to about 45 wt %, based on the total weight of the Part A fluid.

The Part A composition can further comprise a surfactant to provide wetting on film substrate. Some suitable surfactants include surfactants that are miscible with ink-aggregating agent and polymers, i.e., those that do not form precipitates or aggregates when mixing. Some useful surfactants include cationic, non-ionic, and amphoteric surfactants. Some suitable cationic surfactants include, for example, quaternized ammonium or pyridinium surfactants, such as dodecyltrimethylammonium chloride, cetyltrimethylammonium bromide, cetyltrimethylpyridinium chloride and others. Some suitable non-ionic surfactants include ethoxylated acetylene diols (e.g. Surfynol® series from Evonik), ethoxylated primary alcohols (e.g. Neodol® series from Shell) and secondary alcohols (e.g. Tergitol® series from Dow Chemical), Pluronic® block copolymer surfactants, sulfosuccinates (e.g. Aerosol® series from Cytec), organosilicones (e.g. Dynol™ series from Evonik) and fluoro surfactants (e.g. Zonyl® series from Chemours). Amphoteric surfactants that, within a certain pH range, are cationic may also be used. In this case the pH of the liquid composition must be adjusted below the isoelectric point of the surfactant. Some examples of useful zwitterionic surfactants include N,N-dimethyl-N-tetradecyl amine oxide (NTAO), N,N-dimethyl N-hexadecyl amine oxide (NHAO) and related amine oxide compounds. Another example is N-dodecyl-N,N-dimethyl glycine. Yet other examples include phosphates, phosphites, phosphonates, lecithins and the like, and phosphonate esters such as phosphomyelin. Surfactants may be used, typically in the amount of about 0.1 to about 10% and more typically about 0.5 to about 5%, based on the total weight of the primer fluid.

Part A may further comprise additional additives to modify viscosity, prevent film curling or improve block resistance including, but not limit to, colloidal silica dispersion and wax emulsion. Preferred colloidal silica dispersions are nano-size silica particles stabilized by cationic charge, or no charge, as long as it is stable when mixing with ink aggregating agent. Examples include surface treated silica SNOWTEX® ST-AK, ST-AK-ML, ST-AK-L, ST-AK-A and ST-AK-XK (Nissan Chemical America, Houston TX), and silica with elongated shape SNOWTEX® ST-OUP and string-of-pearls SNOWTEX® ST-PS-SO and ST-PS-MO. Colloidal silica may be used typically in the amount of 1% to 50% based on the total weight of the Part A fluid. Examples of wax emulsions include, but not limit to, olefin wax such as LDPE, HDPE and PP, paraffin wax, carnauba wax, and amide wax colloidal stabilized with non-ionic emulsification so it is stable when mixing with ink aggregating agent. Preferred wax examples are AQUACER 539, AQUACER 513, AQUACER 519 and AQUACER 497 (BYK-Chemie Wesel, Germany). Wax may be used, typically in the amount of 0.05% to 5%, based on the total weight of the Part A fluid.

Other ingredients in the primer Part A fluid may further include, but are not limited to, humectants and biocides. Biocides prevent microbial degradation-their selection and use are generally well known in the art. Suitable humectants are the same as those suitable for use in colored inkjet inks, as discussed in further detail below.

### Primer Part B

Primer Part B comprises a water soluble or dispersible co-reactant which can undergo chemical reaction with primer Part A at temperature lower than 85° C. Suitable co-reactants include monomers, oligomers and polymers comprising functionalities selected from polyisocyanate, epoxy, epoxy silane, carbodiimide, and mixtures thereof. Typically, the amount of the co-reactant is in the range of 70% to 100%, based on the total weight of Part B. Examples of suitable co-reactants include polyisocyanate crosslinkers such as Bayhydur® 304 and Bayhydur® 3100 from Covestro (Leverkusen, Germany); co-reactants with epoxy groups such as Denacol® 321, 920, 512 and 614B from Nagase Chemicals Ltd. (Osaka, Japan); carbodiimide co-reactants such as Carbodilite® V-02, V-02-L2, SV-L2, E-02 and E-03A from NISSHINBO (Tokyo, Japan), and Picassian® XL-702 and XL-703 from Stahl Polymers (Waalwijk Netherlands); silane crosslinkers such as Silquest® A-187 and the likes from Momentive (Waterford, NY) and various Dynasylan® silane couple agents from Evonik (Essen, Germany).

### Application of Primer

Prior to printing of inkjet inks, a film substrate is coated with the primer fluid of the present disclosure by various coating methods available including flexographic, gravure, rod, spray, roll, curtain and knife coating methods. Preferred methods are flexographic, gravure and rod coating methods. The application of the primer can be in-line or off-line with the inkjet ink printing process depending on printer design and machine integration.

Since primer Part A and Part B solutions chemically reacts at temperature lower than 85° C., the two parts should be mixed together on the same day when a film/print substrate is to be coated. The mixed primer solution can be used as long as it is not gelled due to chemical reaction(s). Typically, the coating process occurs within 24 hrs of mixing Part A and Part B of the primer.

Regardless of coating methods, a film/print substrate coated with a primer needs to be sufficiently dried before printing of inkjet inks. The drying process is not limited to any method, varying from hot air, infrared and near-infrared radiation, as long as the drying temperature is not too high to damage the film's integrity. Typically, the drying temperature ranges from 40° C. to 120° C., and more typically, from 50° C. to 100° C. The coating thickness of the dried primer can vary from 0.3 to 10 μm, preferably from 0.5 to 8 μm, more preferably from 0.6 to 5 μm. One skilled in the art can adjust and optimize the printed image quality of an ink or an ink set by adjusting the primer coating's thickness and tackiness, drying speed, haziness, adhesion, etc. The time interval between primer coating and inkjet printing is not limited, ranging from seconds to days. Chemical reaction(s) between the coated primer and inkjet ink(s) are not required to achieve print images with superior quality using the 2-part primer of the present disclosure.

### Ink Sets

The term “ink set” refers to all the individual inks or other fluids an inkjet printer is equipped to jet. The white inks used to print the image after printing the colored inks or the white ink used to print prior to printing the colored inks are considered part of the ink set. This ink set, together with the primer fluid, forms an inkjet printing fluid set.

In one preferred embodiment, the ink set comprises at least two differently colored inkjet inks, at least one of which is a white pigmented inkjet ink as described above.

In another preferred embodiment, the ink set comprises at least four differently colored inkjet inks, wherein at least one is a cyan inkjet ink, at least one is a magenta inkjet ink, at least one is a yellow inkjet ink, and at least one is a white inkjet ink.

In addition to the colored inkjet inks just mentioned, it is also preferable to include a black inkjet ink in the ink set.

In addition to the CMYKW inks mentioned above, the ink sets may contain additional differently colored inks, as well as different strength versions of the CMYKW and other inks.

For example, the ink sets of the present invention can comprise full-strength versions of one or more of the inks in the ink set, as well as “light” versions thereof.

Additional colors for the inkjet ink set include, for example, orange, violet, green, red and/or blue.

The preferred inks in the ink sets are pigmented inks.

### Pigments

The colorant used for printing the colored image may be a dye or a pigment. Dyes include disperse dyes, reactive dyes, acid dyes and the like. The term “pigment” as used herein means an insoluble colorant that requires to be dispersed with a dispersant and processed under dispersive conditions in the presence of a dispersant. Pigmented inks are preferred.

Pigments suitable for being used are those generally well-known in the art for aqueous inkjet inks. The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include, but not limited to: cyan pigments from Pigment Blue 15:3 and Pigment Blue 15:4; magenta pigments from Pigment Red 122 and Pigment Red 202; yellow pigments from Pigment Yellow 14, Pigment Yellow 74, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 254, Pigment Red 184, Pigment Red 264 and Pigment Red PV19; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; and black pigment carbon black. The pigment names and abbreviations used herein are the “C.I.” designation for pigments established by Society of Dyers and Colourists, Bradford, Yorkshire, UK and published in The Color Index, Third Edition, 1971.

Examples of white color materials include, but are not limited to, white inorganic pigments such as Titanium Oxide, Zinc Oxide, zinc sulfide, antimony oxide, and zirconium oxide. Besides such white inorganic pigments, white organic pigments such as white hollow resin particles and polymeric particles can also be used. The preferred pigment for the aqueous pigmented white ink is titanium dioxide. The Titanium dioxide (TiO2) pigment employed may be in the rutile or anatase crystalline form. It is commonly made by either a chloride process or a sulfate process. In the chloride process, TiCl4 is oxidized to TiO2 particles. In the sulfate process, sulfuric acid and ore containing titanium are dissolved, and the resulting solution goes through a series of steps to yield TiO2. Both the sulfate and chloride processes are described in greater detail in “The Pigment Handbook”, Vol. 1, 2nd Ed., John Wiley & Sons, NY (1988), the relevant disclosure of which is incorporated by reference herein for all purposes as if fully set forth.

The titanium dioxide particles can have a wide variety of average particle sizes of about 1 micron or less, depending on the desired end use application of the ink. For applications demanding high hiding or decorative printing applications, the titanium dioxide particles preferably have an average size of less than about 1 micron (1000 nanometers). Preferably, the particles have an average size of from about 50 to about 950 nanometers, more preferably from about 75 to about 750 nanometers, and still more preferably from about 100 to about 500 nanometers. These titanium dioxide particles are commonly called pigmentary TiO2.

For applications demanding white color with some degree of transparency, the pigment preference is “nano” titanium dioxide. “Nano” titanium dioxide particles typically have an average size ranging from about 10 to about 200 nanometers, preferably from about 20 to about 150 nanometers, and more preferably from about 35 to about 75 nanometers. An ink comprising nano titanium dioxide can provide improved chroma and transparency, while still retaining good resistance to light fade and appropriate hue angle. A commercially available example of an uncoated nano grade of titanium oxide is P-25, available from Degussa (Parsippany N.J.).

The titanium dioxide pigment may be substantially pure titanium dioxide or may contain other metal oxides, such as silica, alumina and zirconia. Other metal oxides may become incorporated into the pigment particles, for example, by co-oxidizing or co-precipitating titanium compounds with other metal compounds. If co-oxidized or co-precipitated metals are present, they are preferably present as the metal oxide in an amount from about 0.1 wt % to about 20 wt %, more preferably from about 0.5 wt % to about 5 wt %, and still more preferably from about 0.5 wt % to about 1.5 wt %, based on the total titanium dioxide pigment weight.

The titanium dioxide pigment may also bear one or more metal oxide surface coatings. These coatings may be applied using techniques known by those skilled in the art. Examples of metal oxide coatings include silica, alumina, alumina-silica, boria and zirconia, among others. Such coatings may optionally be present in an amount of from about 0.1 wt % to about 10 wt %, and preferably from about 0.5 wt % to about 3 wt %, based on the total weight of the titanium dioxide pigment. These coatings can provide improved properties including reducing the photoreactivity of the titanium dioxide. Commercial examples of such coated titanium dioxides include R700 (alumina-coated, available from Chemours, Wilmington Del.), RDI-S (alumina-coated, available from Kemira Industrial Chemicals, Helsinki, Finland), R706 (available from Chemours, Wilmington Del.) and W-6042 (a silica alumina treated nano grade titanium dioxide from Tayco Corporation, Osaka Japan).

The titanium dioxide pigment may also bear one or more organic surface coatings, such as, for example, carboxylic acids, silanes, siloxanes and hydrocarbon waxes, and their reaction products with the titanium dioxide surface. The amount of organic surface coating, when present, generally ranges from about 0.01 wt % to about 6 wt %, preferably from about 0.1 wt % to about 3 wt %, more preferably about 0.5 wt % to about 1.5 wt %, and still more preferably about 1 wt %, based on the total weight of the pigment.

### Polymeric Dispersant

Traditionally, pigments are stabilized by dispersing agents, such as polymeric dispersants or surfactants, to produce a stable dispersion of the pigment in the vehicle. More recently though, so-called “self-dispersible” or “self-dispersing” pigments (hereafter “SDP”) have been developed. As the name would imply, SDPs are dispersible in water without dispersants.

The polymeric dispersant for the non-self-dispersing pigment(s) may be a random or a structured polymer. Typically, the acrylic based polymer dispersant is a copolymer of hydrophobic and hydrophilic monomers. Some examples of hydrophobic monomers used are methyl methacrylate, n-butyl methacrylate, 2-ethylhexyl methacrylate, benzyl methacrylate, 2-phenylethyl methacrylate and the corresponding acrylates. Examples of hydrophilic monomers are methacrylic acid, acrylic acid, dimethylaminoethyl (meth)acrylate and salts thereof. Quaternary salts of dimethylaminoethyl (meth)acrylate may also be employed. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. Nos. 6,117,921, 6,262,152, 6,306,994 and 6,433,117.

The “random polymer” also includes polyurethanes. Particularly useful are the polyurethane dispersant disclosed in U.S. Patent Application Publication No. 2012/0214939 where the polyurethane dispersant is crosslinked after dispersing a pigment to form a pigment dispersion.

Another type of suitable polymeric dispersant is Styrene Maleic Anhydride (SMA) copolymer. “Styrene Maleic Anhydride copolymer”, or “SMA copolymer”, means a polymer formed of styrene and maleic anhydride monomers, and optionally one or more further comonomers. The copolymers can have the molar ratio of the styrene/maleic anhydride repeat units from 0.2 to 5, preferably from 0.5 to 2. The dispersing agent is generally in the form of a hydrolyzed solution of SMA copolymer. The hydrolyzed solution preferably comprises the SMA copolymer dissolved in an aqueous alkaline solution. An aqueous alkaline solution is useful to hydrolyze the SMA copolymer, because the copolymer is not readily soluble in water. The hydroxyl ions of the alkaline solution hydrolyze, or react with, a carbonyl carbon on the anhydride's ring, cleaving a carbon-oxygen single bond. The reaction opens the ring, resulting in the formation of a mono-acid group where the hydroxyl ion reacts with the carbonyl carbon and a mono-acid carboxylate group. The aqueous alkaline solution used to dissolve the SMA copolymer is preferably prepared from ammonium hydroxide, sodium hydroxide, potassium hydroxide, or an organic amine. Suitable hydrolyzed SMA copolymer solutions for the present invention include those commercially available from Polyscope Polymers under the trade names XIRAN® SL.

### Colored Pigment Dispersion

The color pigment dispersion which are stabilized by added polymer dispersant may be prepared by methods known in the art. It is generally desirable to make the stabilized pigment in a concentrated form. The stabilized pigment is first prepared by premixing the selected pigment(s) and polymeric dispersant(s) in an aqueous carrier medium (such as water and, optionally, a water-miscible solvent), and then dispersing or deflocculating the pigment. The premixing step is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 120 minutes. The subsequent dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. These various dispersion processes are in a general sense well known in the art, as exemplified by U.S. Pat. Nos. 5,022,592, 5,026,427, 5,310,778, 5,891,231, 5,976,232 and 20,030,089277. The disclosures of each of these publications are incorporated by reference herein for all purposes as if fully set forth. Preferred are 2-roll mill, media mill, and by passing the mixture through a plurality of nozzles within a liquid jet interaction chamber at a liquid pressure of at least 5,000 psi.

After the milling process is complete the color pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

### White Pigment Dispersion

One or more dispersants described for colored pigment are also employed to stabilize the titanium dioxide. It is generally desirable to make the stabilized TiO2 pigment in concentrated slurry form. TiO2 slurry is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 600 minutes. The amount of titanium dioxide present in the slurry composition is preferably from about 35 wt % to about 80 wt %, based on the total slurry weight, more preferably from about 50 wt % to about 75 wt %, based on the total weight of the slurry. The titanium dioxide has a 50% average particle size (hereinafter referred to as “D50”) that is preferably in the range of 50 to 500 nm, more preferably in the range of 150 to 350 nm. The titanium dioxide having a D50 within these ranges enables printed film to exhibit satisfactory opacity of the image, which enables formation of an image with high quality.

In the case of color pigments, the ink may contain up to approximately 30%, preferably about 0.1 to about 25%, and more preferably about 0.25 to about 10%, pigment by weight based on the total ink weight. If an inorganic pigment such as TiO2 pigment is selected, the ink will tend to contain higher weight percentages of pigment than with comparable inks employing color pigment, and may be as high as about 75% in some cases, since inorganic pigments generally have higher specific gravities than organic pigments.

Post Modification of a Polymeric Dispersant after Formation of a Pigment Dispersion

The polymeric dispersant dispersing a pigment may be crosslinked after a pigment dispersion is prepared to form a crosslinked pigment dispersion prior to its inclusion in an inkjet ink. The crosslinkable polymeric dispersant are polymers substituted with crosslinkable moieties selected from the group consisting of acetoacetoxy, acid, amine, epoxy, hydroxyl, blocked isocyanates and mixtures thereof. The crosslinking agent is selected from a group consisting of acetoacetoxy, acid, amine, anhydride, epoxy, hydroxyl, isocyanates, blocked isocyanates and mixtures thereof. In the crosslinking step, a crosslinking agent is added to the pigment dispersion after the pigment is dispersed and crosslinking took place by heating the mixture for several hours at elevated temperature. After the crosslinking step excess polymer can be removed by purification processes such as ultrafiltration. Specific examples of crosslinking moiety/agent pairs are hydroxyl/isocyanate and acid/epoxy.

### Ink Polymeric Binder

An ink binder for CMYKW inks is a polymeric compound or a mixture of polymeric compounds that is added to an ink formulation. The binder can impart properties to the printed material that, for example, gives greater durability to the printed material. Typical polymers used as binders in inkjet inks include polyurethane dispersions and polyurethane solutions, acrylics, styrene acrylics, styrene butadienes, styrene butadiene acrylonitriles, neoprenes, ethylene acrylic acids, ethylene vinyl acetate emulsions, latexes and the like. The binder may be a solution or stabilized as an emulsion by having ionic substituents such as carboxylic acids, sulfur containing acids, amine groups, and other similar ionic groups. Alternatively, the binder may be stabilized by external surfactants. The binder can be used singly or in combination with other binders. Typically, the binder is a polyurethane and acrylic. The binder is typically present in an ink in an amount of at least 0.2% by weight based on the total weight of the ink. Examples of ink binder polymer include polyurethane polymers such as Takelac® WS5100, Takelac® WS4022, Takelac® W5030, XW-Um601 and XW-Um602A from Mitsui Chemicals (Tokyo, Japan); Acrylic polymers, Johncryl® FLX5000-A, Johncryl® FLX5220 and Johncryl® FLX5026A from BASF (Ludwigshafen, Germany).

Typically, a binder is different from the polymer dispersant described above and is non-reactive to the colorant. The binder is typically added to an ink during the final formulation stage, not during the preparation of a pigment dispersion. The binder is typically present in an ink in an amount of at least 0.2% by weight based on the total weight of the ink. The amount can be from 1 to 15 wt %.

### Ink Vehicle

The pigmented ink of this disclosure comprises an ink vehicle typically an aqueous ink vehicle, also known as an aqueous carrier medium, the aqueous dispersion and optionally other ingredients.

The ink vehicle is the liquid carrier (or medium) for the aqueous dispersion(s) and optional additives. The term “aqueous ink vehicle” refers to an ink vehicle comprised of water or a mixture of water and one or more organic, water-soluble vehicle components commonly referred to as co-solvents or humectants. Selection of a suitable mixture depends on requirements of the specific application, such as desired surface tension and viscosity, the selected pigment, drying time of the pigmented ink jet ink, and the type of media onto which the ink will be printed.

Examples of water-soluble organic solvents and humectants include: alcohols, ketones, keto-alcohols, ethers and others, such as thiodiglycol, Sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

A mixture of water and a polyhydric alcohol, such as diethylene glycol, is typical as the aqueous ink vehicle. In the case of a mixture of water and diethylene glycol, the ink vehicle usually contains from 30% water and 70% diethylene glycol to 95% water and 5% diethylene glycol, more typically from 60% water and 40% diethylene glycol to 95% water and 5% diethylene glycol. Percentages are based on the total weight of the ink vehicle. A mixture of water and butyl carbitol is also an effective ink vehicle.

The amount of ink vehicle in the ink is typically in the range of from 70% to 99.8%, and more typically from 80% to 99.8%, by weight based on total weight of the ink.

The ink vehicle can be made to be rapid drying by including solvents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. Typical 1,2-alkanediols are C4-C6 alkanediols with 1,2-hexanediol being most typical. The amount of glycol ether(s) and 1,2-alkanediol(s) added is typically in the range of from 1% to 15%, and more typically from 2% to 10% by weight, based on the total weight of the ink.

Surfactants are commonly added to inks to adjust surface tension and wetting properties. Suitable surfactants include ethoxylated acetylene diols (e.g. Surfynol® series commercially available from Evonik), ethoxylated alkyl primary alcohols (e.g. Neodol® series commercially available from Shell) and secondary alcohols (e.g. Tergitol® series commercially available from Dow Chemical), sulfosuccinates (e.g. Aerosol® series commercially available from Cytec), organosilicones (e.g. DYNOL™ series commercially available from Evonik) and fluoro surfactants (e.g. CAPSTONE™ series commercially available from Chemours). Surfactants are typically used in amounts up to about 3% and more typically in amounts up to 1% by weight, based on the total weight of the ink.

Other ingredients, additives, may be formulated into the inkjet ink, to the extent that such other ingredients do not interfere with the stability and jettability of the inkjet ink. This may be readily determined by routine experimentation by one skilled in the art.

Inclusion of sequestering (or chelating) agents such as ethylenediaminetetraacetic acid, iminodiacetic acid, ethylenediamine-di(o-hydroxyphenylacetic acid), nitrilotriacetic acid, dihydroxyethylglycine, trans-1,2-cyclohexanediaminetetraacetic acid, diethylenetriamine-N,N,N′,N″,N″-pentaacetic acid, and glycoletherdiamine-N,N,N′,N′-tetraacetic acid, and salts thereof, may be advantageous, for example, to eliminate deleterious effects of heavy metal impurities.

Biocides may be used to inhibit growth of microorganisms.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 45 dyne/cm at 25° C. Viscosity can be as high as 30 cP at 25° C., but is typically much lower, more typically less than 10 cP at 25° C. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic. Preferred pH for the ink is in the range of from about 6.5 to about 8.5.

### Printing

The present method relates to digitally printing a non-porous plastic film substrate. Typically, this involves the following steps:
(a) providing an inkjet printer that is responsive to digital data signals;
(b) providing a non-porous plastic substrate;
(c) mixing an aqueous primer composition comprising Part A and Part B;
(d) applying the aqueous primer composition onto the non-porous plastic substrate followed by drying to form a coating with a dry thickness of from 0.4 to 5.0 micron;
(e) loading the printer with an aqueous white inkjet ink and one or more aqueous non-white colored inkjet inks, wherein said white inkjet ink comprising a titanium oxide pigment dispersion, and a polyurethane binder or an acrylic binder, said titanium oxide pigment dispersion having a particle size of D50 in the range of 200 to 350 nm; and wherein at least one of the aqueous non-white colored inkjet inks comprising a pigment dispersion, and a second-polyurethane binder or a second acrylic binder; and
(f) printing onto the primer coated substrate of step (d) using the white inkjet ink and non-white colored inkjet inks in response to digital signals.

The time interval between step (d) and (f) is not particularly limited. It can range from seconds to days. In step (f), the white ink can be printed first as a background image followed by color ink. Alternatively, the non-white colored inks can be first printed and then covered by the white ink in a reverse printing setting. Drying between the non-white colored inks or between white and non-white colored inks are optional.

Printing can be accomplished by any inkjet printer equipped for handling and printing a film substrate. A film printed with pigmented inks is dried at elevated temperature after printing. The range of drying temperature varies with printer and dryer design and line speed, and is not too high to cause damage to the integrity of the printed film. Generally, the drying temperature is not higher than 120° C., preferably not higher than 100° C., more preferably, not higher than 95° C.

### Lamination

Laminations are used throughout the flexible packaging industry to create packages that have desired characteristics that one material alone cannot provide. Typically a film printed with ink(s) is laminated to another film with the printed ink(s) sandwiched between two films. If a primer is utilized, the primer is situated between the films as well. Multilayered structures can be represented as Film/Adhesive/ink/primer/Film where each line stands for a layer.

The most common lamination process involves combining two or more films together with packaging adhesives and aid of thermal energy and pressure. The adhesives can be solvent-free, water-based or solvent-based depending on the chemistry. The energy required for laminating two substrates is usually supplied as heat energy, both in the laminating nip and in a hot room for curing at elevated temperature. In the case of room temperature curing, heat is provided solely at the laminating nip rolls. An adhesive can be applied to the ink printed film side or the non-printed film side. In the case of solvent and water-based adhesives, water and solvent are dried off before laminating to the second web. Almost all types of adhesives come in two parts, with one labeled as adhesive and the other as curing agent. They react when mixed together forming interlocking crosslinked structure to achieve bonding strength, water resistance and heat resistance. The adhesive curing reaction typically takes 3 to 10 days to reach a final cured bond at room temperature. Bonding strength is one of the critical properties of a laminate structure. After an adhesive is thoroughly cured, the bonding strength can be measured on an Instron using a proper load cell.

### EXAMPLES

The invention is further illustrated by, but not limited to, the following examples, in which parts and percentages are by weight unless otherwise noted.

### Ingredients and Abbreviations

DBTL=dibutyltindilaurate
DMPA=dimethylol propionic acid
EDA=ethylene diamine
IPDI=isophoronediisocyanate
TEA=triethylamine
MDEA=methyldiethanolamine
DETA=diethylenetriamine
MEK=methyl ethyl ketone
TMP=TrimethylolPropane
CHDM=1, 4-cyclohexanedimethanol
Unless otherwise noted, the above chemicals were obtained from Aldrich (Milwaukee, WI) or other similar suppliers of laboratory chemicals.
Terathane® T650-polyether polyol from Invista (Wilmington, DE)
Tegomer® D3403-polyether polyol from Evonik (Essen, Germany)
Eternacoll®UT-200 and UH-50-polycarbonate polyol from UBE industries (Tokyo, Japan)
Vestamin®A95-50% sodium 2-[(2-aminoethyl)amino]ethanesulfonate water solution from Evonik (Essen, Germany)
Surfynol®440, 420 and 465-nonionic surfactant from Evonik (Essen, Germany)
TegoWet® 280-silicone surfactant from Evonik (Essen, Germany)
SNOWTEX® ST-AK-ML-28% solids nano-silica dispersion from Nissan Chemical America (Houston, TX)
Levasil CC151-28% solids aqueous dispersion of colloidal silica from Nouryon (Amsterdam, Netherlands)
Levasil CC301-15% solids aqueous dispersion of colloidal silica from Nouryon (Amsterdam, Netherlands)
Bayhydur® 3100-100% solids water dispersible polyisocyanate hardener from Covestro (Leverkusen, Germany)
Carbodilite V-02-L2-40% solids VOC free polycarbodiimide based crosslinking aqueous solution from Nisshinbo Chemical Inc. (Tokyo, Japan)
ROBOND™ CR 9-101-100% solids water dispersible isocyanate co-reactant from Dow Chemical Co. (Midland, MI)
ROBOND™ L-2150-waterbased polyurethane dispersion laminating adhesives from Dow Chemical Co. (Midland, MI)
ADCOTE™ 555-isocyanate terminated polyester urethane component of a two-component laminating adhesive system in ethyl acetate, and ADCOTE™ 536B—other part of the two-component laminating adhesive system in ethyl acetate from Dow Chemical Co. (Midland, MI)

### Pigment Dispersion

### Cyan Pigment Dispersion-1

Cyan Dispersion-1 was prepared according to a procedure disclosed in U.S. Patent Application Publication No. 2012/0214939, the disclosure of which is incorporated by reference herewith for all purposes as if fully set forth. A cyan TRB2 pigment was employed, and the dispersant was crosslinked after dispersing the pigment.

### Cyan Pigment Dispersion-2

Cyan Pigment Dispersion-2 was prepared according to a procedure disclosed in U.S. Patent Application Publication No. 2012/0214939, the disclosure of which is incorporated by reference herewith for all purposes as if fully set forth. A cyan TRB2 pigment was employed, and the dispersant was neutralized with triethyl amine and was not crosslinked after pigment was dispersed.

### Ink Polymer Binder

### Ink Binder-1

To a dry, alkali- and acid-free flask, equipped with an addition funnel, a condenser, stirrer and a nitrogen gas line were added 15.8 g CHDM, 104.7 g Terathane T650, 4.0 g TMP, and 118 g acetone. The contents were heated to 40° C. and thoroughly mixed. 120 g IPDI was then added to the flask via the addition funnel at 40° C. over 5 min, with any residual IPDI being rinsed from the addition funnel into the flask with 2 g acetone.

The flask temperature was raised to 50° C. After holding at 50° C. for 240 minutes, an additional 15.8 g of DMPA, followed by 11 g of TEA, were added to the flask via the addition funnel, which was then rinsed with 2 g of acetone. The flask temperature was then raised again to 50° C. and held at 50° C. until NCO % reached 2.0% or less.

With the temperature at 50° C., 570 g of deionized (DI) water was added over 10 minutes, followed by 38 g EDA (as a 10% solution in water) over 5 minutes, via the addition funnel. The mixture was held at 50° C. for 1 hr, then cooled to room temperature.

Acetone (˜122.0 g) was removed under vacuum, leaving a final dispersion of polyurethane with about 30.0% solids by weight.

### Ink Binder-2

To a dry, alkali- and acid-free flask, equipped with an addition funnel, a condenser, stirrer and a nitrogen gas line were added 21 g MDEA, 180 g Terathane T650, 7.0 g TMP, and 192 g acetone. The contents were heated to 40° C. and thoroughly mixed. 202 g IPDI was then added to the flask via the addition funnel at 40° C. over 5 min, with any residual IPDI being rinsed from the addition funnel into the flask with 10 g acetone.

The flask temperature was raised to 50° C. After holding at 50° C. for 240 minutes, an additional 27 g of DMPA, followed by 9 g of TEA, were added to the flask via the addition funnel, which was then rinsed with 10 g of acetone. The flask temperature was then raised again to 50° C. and held at 50° C. until NCO % reached 2.2% or less.

With the temperature at 50° C., 890 g of deionized (DI) water was added over 10 minutes, followed by 128 g EDA (as a 5% solution in water) over 5 minutes, via the addition funnel. The mixture was held at 50° C. for 1 hr, then cooled to room temperature.

Acetone (˜212.0 g) was removed under vacuum, leaving a final dispersion of polyurethane with about 30.0% solids by weight.

### Ink Binder-3

Ink Binder-3 is the polyurethane PUD EX2 described in U.S. Patent No. U.S. Pat. No. 9,255,207, which is incorporated by reference herein for all purposes as if fully set forth.

### Preparation of Inks

Inks used in the examples were made according to standard procedures in the inkjet art. Ingredient amounts are in weight percent of the final ink. Polymer binders and colorants are quoted on a solids basis. As an example of ink preparation, the ink vehicle was prepared and added with stirring to the aqueous ink binder. After stirring until a homogeneous mixture was obtained, the solution was added to the pigment dispersion and mixed until homogeneous again. Inks were prepared using ingredients listed in Table 1 below.

TABLE 1

| | Ink-1 | Ink-2 | Ink-3 |
|---|---|---|---|
| Ingredients | (Wt %, based on total weight of ink) | | |
| Cyan Pigment-1 | 3% | | |
| Cyan Pigment-2 | | 3% | 3% |
| Ink Binder-1 | | 3% | |
| Ink Binder-2 | | | 3% |
| Ink Binder-3 | 6% | | |
| 1,3-Propanediol | 18% | 18% | 18% |
| 1,2-Propanediol | | 15% | 15% |
| Surfynol 420 | 0.56% | 0.5% | 0.5% |
| Surfynol 440 | 0.1% | | |

| | |
|---|---|
| DI water | Balanced to 100% |

### Primer Binder P-1

To a dry, alkali- and acid-free flask, equipped with an addition funnel, a condenser, stirrer and a nitrogen gas line were added 40 g CHDM, 160 g Eternacoll UT-200, 57 g Tegomer D3403, 8.3 g DMPA, 6.2 g TEA and 200 g MEK. The contents were heated to 50° C. and thoroughly mixed. 127 g IPDI was then added to the flask via the addition funnel at 40° C. over a period of 5 min, with any residual IPDI being rinsed from the addition funnel into the flask with 10 g MEK.

The flask temperature was raised to 65° C., held until the NCO % reached 1.45% or less. The flask was then cooled to 55° C., and 877 g deionized (DI) water was added over 10 minutes, followed by 93 g DETA (as a 5% solution in water) over 5 minutes, via the addition funnel. The mixture was held at 50° C. for 1 hour, then cooled to room temperature.

MEK (˜210 g) was removed under vacuum, leaving a final dispersion of polyurethane with about 30.0% of solids by weight.

Following procedures similar to the preparation of Primer Binder P-1, Primer Binders P2-P5 were prepared using ingredients listed in Table 2 below.

TABLE 2

| Ingredient/ | Primer | Primer | Primer | Primer |
|---|---|---|---|---|
| Weight (g) | Binder P-1 | Binder P-2 | Binder P-3 | Binder P-4 |
| IPDI | 127 | 182 | 141 | 141 |
| DMPA | 8.3 | | 9.2 | 9.2 |
| Eternacoll | 160 | 120 | 178 | 178 |
| UT200 | | | | |
| Tegomer | 57 | 110 | 64 | 64 |
| D3403 | | | | |
| TEA | 6.2 | | 6.9 | 6.9 |
| MDEA | | 8 | 37 | 20 |
| Vestamine | | 25 | | |
| A95 | | | | |
| DETA | 4.7 | 3.5 | 5.0 | 5.3 |
| CHDM | 40 | 65 | | 20 |

### Preparation of Primers

Primers Part A's were prepared using ingredients listed in Tables 3, 4 and 5 by combining the listed ingredients with agitation and mixing until a homogeneous mixture is obtained. Primer Part B's were used as listed in Table 6.

TABLE 3

| Component | | | | |
|---|---|---|---|---|
| weight % | | | | Primer |
| (dry weight basis) | Primer A-1 | Primer A-2 | Primer A-3 | A-4 |
| Magnesium Nitrate | 4.4 | 4.0 | 4.4 | 4.4 |
| hexahydrate | | | | |
| 1,2-Propanediol | 4.0 | 4.0 | 2.5 | |
| 1,3-Propanediol | | | | 5 |
| Surfynol 465 | 0.66 | 0.66 | 0.66 | 0.66 |
| TegoWet 280 | 0.33 | 0.25 | 0.33 | 0.33 |
| Primer Binder P-1 | 18.7 | 17 | 21.45 | 24.2 |
| Snowtex | 10 | | 7.15 | 4.4 |
| ST-AK-ML | | | | |
| Levasil CC301 | | 9 | | |

| | |
|---|---|
| DI water | Balance to 100% |

TABLE 4

| Component weight % | Primer | Primer | Primer | Primer |
|---|---|---|---|---|
| (dry weight basis) | A-5 | A-6 | A-7 | A-8 |
| Magnesium Nitrate | 4.0 | 4.0 | 4.0 | 4.0 |
| hexahydrate | | | | |
| 1,2-Propanediol | 4.0 | 4.0 | 4.0 | 4.0 |
| 1,3-Propanediol | | | | |
| Surfynol 465 | 0.6 | 0.66 | 0.6 | 0.66 |
| TegoWet 280 | 0.25 | 0.25 | 0.25 | 0.25 |
| Primer Binder P-2 | 22 | 19.5 | | |
| Primer Binder P-4 | | | 22 | 19.5 |
| Snowtex ST-AK-ML | 4 | 6.5 | 4 | 6.5 |
| Levasil CC301 | | | | |

| | |
|---|---|
| DI water | Balance to 100% |

TABLE 5

| Component weight % | Primer | Primer | Primer | Primer | Primer |
|---|---|---|---|---|---|
| (dry weight basis) | A-9 | A-10 | A-11 | A-12 | A-13 |
| Magnesium Nitrate | 4.0 | 4.0 | 4.0 | 3.6 | 3.6 |
| hexahydrate | | | | | |
| 1,2-Propanediol | 4.0 | 4.0 | 4.0 | 3.6 | 3.6 |
| 1,3-Propanediol | | | | | |
| Surfynol 465 | 0.6 | 0.6 | 0.6 | 0.55 | 0.55 |
| TegoWet 280 | 0.25 | 0.25 | 0.25 | 0.23 | 0.23 |
| Primer Binder P-3 | 19.5 | 22 | 19.5 | 20 | 17.55 |
| Snowtex ST-AK-ML | 6.5 | | | | |
| Levasil CC301 | | 4 | 6.5 | | |
| Levasil CC151 | | | | 3.5 | 5.7 |

| | |
|---|---|
| DI water | Balance to 100% |

TABLE 6
Primer Part B

| | |
|---|---|
| Primer B-1 | ROBOND ™ CR 9-101 |
| Primer B-2 | Carbodilite V-02-L2 |
| Primer B-3 | Bayhydur ® 3100 |

### Primer Coating Preparation

Primer fluid was applied to Mylar MLBT, a clear PET film from DuPont Teijin Film, using a Gardco film applicator rod having a wire size of 2.5 (Paul N. Gardner Inc., Florida, USA) to form a coating having a dry thickness varying from 0.5 to 2.0 μm depending on solids and viscosity. For comparative primer coating, Part A was applied alone to the film. For inventive primer fluids, Part A and Part B was mixed together for 5 to 10 minutes to ensure homogeneous mixing and then applied to the film. In both cases, coating was dried in a convection oven for 3 minutes at 65° C.

Printing with Ipsio Printer

The primer coated Mylar MLBT film was printed with Ink-2 from Table 1 using a Ricoh IPSiO GX e5500 printer. A 3×9 inches solid block with ink coverage of about 7-10 g/m² was printed with the printer set at the 8-pass color mode. The printed film was subsequently dried at 65° C. for 3 minutes.

Printing with Samba Printhead Rig

The primer coated Mylar MLBT from DuPont Teijin Film was printed with Ink −1 and −3 from Table 1 using a lab printing system. In this printing system, inks were jetted from a mounted stationery Fujifilm (Tokyo, Japan) Samba G3L printhead onto the film held to the rotating cylinder underneath. A 1×4 inches solid block with an ink coverage of about 10 g/m² was printed. The printed film was subsequently dried at 65° C. for 3 minutes.

### Lamination Preparation and Lamination Strength Testing

Ink printed Mylar film was laminated to a 30 μm thick medium density polyethylene film (MDPE) supplied by Bemis (Sheboygan Falls, WI) with a dry bonding process using flexible laminating adhesives from Dow Chemical (Midland, MI) as listed in table 7.

TABLE 7
Dow Chemical Flexible Packaging Laminating Adhesives

| | | | | Mixing ratio of |
|---|---|---|---|---|
| | Solvent | Part 1 | Part 2 | Part 1:Part 2 |
| Adhesive A | Water | ROBOND L-2150 | CR9-101 | 100:4 |
| Adhesive B | Ethyl Acetate | ADCOTE 555 | ADCOTE536B | 100:13 |

With respect to the laminating process, adhesive was applied on top of the ink with a Gardco film applicator rod having a wire size of 5 (Paul N. Gardner Inc., Florida, USA) and dried at 65° C. for 3 minutes to form a dry adhesive layer with thickness varying from 2.0 to 3.5 μm. Within 5 minutes of drying, MDPE film was laid on top of the adhesive and pressed down with a hand roller by rolling it back and forth 20 times to form the laminated structure of Mylar/primer/ink/adhesive/MDPE. The formed laminate was stored at 21-23° C. and atmosphere humidity for 6 days to complete the curing process. T-peel strength of the laminate was then measured using ASTM 1876 on the Instron with T-peel rate of 10 in/min and output value as Newton/inch (N/inch). Lamination strength was reported with the following rating criteria.
Rating 1, lower than IN/inch
Rating 2, between IN/inch and 2.5N/inch
Rating 3, between 2.5N/inch and 3.5N/inch
Rating 4, higher than 3.5 N/inch

TABLE 8
Lamination Strength with Ink-2 and Adhesive A

| Primer | Lamination T-peel Strength Rating |
|---|---|
| Primer A-1 | 1 |
| Primer A-2 | 1 |
| Primer A-3 | 2 |
| Primer A-4 | 1 |
| Primer A-1 mixed with Primer B-1 | 2 |
| with weight ratio of 100:4 | |
| Primer A-1 mixed with Primer B-3 | 2 |
| with weight ratio of 100:4 | |
| Primer A-2 mixed with Primer B-1 | 2 |
| with weight ratio of 100:4 | |
| Primer A-3 mixed with Primer B-2 | 2 |
| with weight ratio of 100:4 | |
| Primer A-4 mixed with Primer B-2 | 2 |
| with weight ratio of 100:4 | |

TABLE 9
Lamination Strength with Ink-2 and Adhesive A

| | Lamination T-peel strength |
|---|---|
| Primer | rating |
| Primer A-5 | 2 |
| Primer A-6 | 1 |
| Primer A-7 | 2 |
| Primer A-8 | 1 |
| Primer A-9 | 2 |
| Primer A-10 | 1 |
| Primer A-11 | 1 |
| Primer A-11 | 1 |
| Primer A-13 | 1 |
| Primer A-5 mixed with Primer B-1 and | 3 |
| Primer B-3 with weight ratio of 100:4:4 | |
| Primer A-6 mixed with Primer B-1 and | 3 |
| Primer B-3 with weight ratio of 100:4:4 | |
| Primer A-7 mixed with Primer B-1 with | 3 |
| weight ratio of 100:4 | |
| Primer A-8 mixed with Primer B-1 with | 2 |
| weight ratio of 100:4 | |
| Primer A-9 mixed with Primer B-1 with | 4 |
| weight ratio of 100:4 | |
| Primer A-10 mixed with Primer B-1 with | 4 |
| weight ratio of 100:4 | |
| Primer A-10 mixed with Primer B-3 with | 2 |
| weight ratio of 100:2 | |
| Primer A-11 mixed with Primer B-1 with | 4 |
| weight ratio of 100:4 | |
| Primer A-11 mixed with Primer B-3 with | 2 |
| weight ratio of 100:2 | |
| Primer A-12 mixed with Primer B-3 with | 2 |
| weight ratio of 100:2 | |
| Primer A-12 mixed with Primer B-1 with | 4 |
| weight ratio of 100:4 | |
| Primer A-13 mixed with Primer B-1 with | 4 |
| weight ratio of 100:4 | |
| Primer A-13 mixed with Primer B-3 with | 2 |
| weight ratio of 100:2 | |

TABLE 10
Lamination strength with Ink-3 and Adhesive A

| Primer | Lamination T-peel strength rating |
|---|---|
| Primer A-1 | 1 |
| Primer A-7 | 1 |
| Primer A-9 | 2 |
| Primer A-1 mixed with Primer B-1 | 3 |
| with weight ratio of 100:4 | |
| Primer A-7 mixed with Primer B-1 | 4 |
| with weight ratio of 100:4 | |
| Primer A-9 mixed with Primer B-1 | 4 |
| with weight ratio of 100:4 | |

TABLE 11
Lamination Strength with Ink-1 and Adhesive A

| Primer | Lamination T-peel strength rating |
|---|---|
| Primer A-1 | 1 |
| Primer A-1 mixed with Primer B-1 | 2 |
| with weight ratio of 100:2 | |
| Primer A-1 mixed with Primer B-1 | 2 |
| with weight ratio of 100:4 | |
| Primer A-1 mixed with Primer B-1 | 3 |
| with weight ratio of 100:6 | |

TABLE 12
Lamination Strength with Ink-2 and Adhesives A and B

| Primer (Ink-2) | Adhesive B | Adhesive A |
|---|---|---|
| Primer A-1 | 2 | 1 |
| Primer A-1 mixed with Primer | 4 | 2 |
| B-1 with weight ratio of 100:4 | | |

As shown in Tables 8-12, the inventive 2-part primers with Part A and Part B demonstrated superior lamination strength.

1. An ink fluid set comprising:
a) a 2-part aqueous primer coating fluid comprising Part A and Part B, wherein Part A comprising an ink aggregating agent, a water insoluble polymer binder selected from polyurethane polymer, acrylic polymer, polyvinyl acetate copolymer, and mixtures thereof, Part B comprising a water dispersible co-reactant, selected from polyisocyanate, epoxy, epoxy silane, carbodiimide, and mixtures thereof, wherein Part A and Part B are mixed before the primer coating fluid is to be applied to a recording media, and wherein Part A and Part B are mixed at a ratio in the range of from 100:1 to 100:20, based on the total weights of Part A and Part B; and
b) an aqueous inkjet ink comprising an aqueous vehicle, and a pigment, wherein the pigment is stabilized by a polymeric dispersant selected from the group consisting of polyurethane polymer, acrylic polymer, hydrolyzed styrene maleic anhydride copolymer, and mixtures thereof.

2. The ink fluid set of claim 1, wherein the water insoluble polymer binder in Part A is polyurethane polymer.

3. The ink fluid set of claim 2, wherein the water dispersible co-reactant in Part B is polyisocyanate.

4. The ink fluid set of claim 3, wherein the polymeric dispersant is polyurethane polymer.

5. The ink fluid set of claim 3, wherein the polymeric dispersant is acrylic polymer.

6. The ink fluid set of claim 1, wherein the water insoluble polymer binder in Part A is acrylic polymer.

7. The ink fluid set of claim 6, wherein the water dispersible co-reactant in Part B is polyisocyanate.

8. The ink fluid set of claim 7, wherein the polymeric dispersant is polyurethane polymer.

9. The ink fluid set of claim 7, wherein the polymeric dispersant is acrylic polymer.

10. The ink fluid set of claim 1, wherein the water insoluble polymer binder in Part A is polyvinyl acetate copolymer.

11. The ink fluid set of claim 10, wherein the water dispersible co-reactant in Part B is polyisocyanate.

12. The ink fluid set of claim 11, wherein the polymeric dispersant is polyurethane polymer.

13. The ink fluid set of claim 11, wherein the polymeric dispersant is acrylic polymer.
